(19) United States
(12) Patent Application Publication
(10) Pub. No.: US 2008/0092401 A1
(43) Pub. Date: Apr. 24, 2008

(54) Universal blind marking system

(76) Inventor: Tim Richard Holcombe, Redlands, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/818,853

(22) Filed: Jun. 18, 2007

Related U.S. Application Data
(60) Provisional application No. 60/853,502, filed on Oct. 20, 2006.

(51) Int. Cl. B25H 7/00

(52) U.S. Cl. 33/666; 33/528; 33/613

(57) ABSTRACT

A universal blind marking apparatus is disclosed where the system includes components that are universally usable to identify where a wall should be cut or a hole should be drilled. The system includes a plurality of adhesive backed pads that are placed in the corners or along curved surfaces. When the surface to be marked is brought into contact with the pads. Some marking material is transferred through the pad identifying where to cut or drill on the surface. The apparatus also works for the marking of vent holes and the routing of electrical wires. In another embodiment the pads are fabricated with sides having different adhesive properties where the low adhesive side is adhered to an object and when the object is brought in contact with a surface the high adhesive side transfers the pad to the surface.

This application claims the benefit of Provisional 60/853,502 filed Oct. 20, 2006 the entire contents of which is hereby expressly incorporated by reference herein.

### DESCRIPTION

1. Field of the Invention

This invention relates to improvements in a marking system for marking blind areas for cutting or drilling. More particularly, the present invention includes components that are universally usable to identify where a wall should be cut or a hole should be drilled. The system includes a plurality of adhesive backed pads that are placed in the corners or along curved surfaces. Marking material such as ink is applied to the pads, and the surface to be marked is brought into contact with the pads. Some marking material is transferred and the surface is removed identifying where to cut or drill on the surface. The apparatus also works for the marking of vent holes and the routing of electrical wires.

2. Background of the Invention

There are many installation tasks where a hole or cut-out needs to be made. In some cases the location for material removal can only be determined by a feature that exists behind a wall or in an area that is not accessible during construction or installation. The locations or identification of the area to be cut is with a blink marking. Several inventions have been patented on marking systems where the area to be marked is not visible. These marking systems rely upon the shape of the feature behind the wall being essentially the same size and shape. A prime example is with an electrical outlet where the outlet is a standard rectangular shape. Exemplary examples of three different types of outlet locating patents are identified and disclosed herein.

U.S. Pat. No. 4,907,711 issued Mar. 13, 1990 to Charles F. Stuchlilk III, U.S. Pat. No. 4,259,785 issued Apr. 7, 1981 to Robert F. Wortham, U.S. Pat. No. 3,924,331 issued Dec. 9, 1975 to Richard H. Goosen, U.S. Pat. No. 3,888,013 issued Jun. 10, 1975 to Lucien E. Benoit and U.S. Pat. No. 2,898,688 issued Aug. 11, 1959 to R. Cottar all disclose a metal or plastic frame with pins or tips located in the corners of the frame that pierce material placed over the frame to indicate where the corners of the electrical box exist. While they all identify the corner locations where the wall material is to be removed, they require the use of custom outlet boxes, and some require re-use and storage of the device after it is used. Another problem with these types of devices is that they only work with electrical box outlets, and are not configurable for round or free-formed cut-outs.

U.S. Pat. No. 6,708,421 issued Mar. 23, 2004 to David J. Crorey discloses a magnetic junction box locating device. This device requires two separate items to operate. The first item is the plug that fits into the electrical box. The second item is a magnetic plate that is attracted to the first item to identify where the wall board is to be removed. While this patent allows for the identification of the corners of the electrical box, it does not identify the corners for electrical boxes that are larger, or work with round or free-form shapes. Because the patent uses magnetism for locating it is not usable with metal housings such as exhaust fans, ducts or appliances. The components must be stored after use, and are not disposable or configurable for different shapes.

U.S. Pat. No. 6,226,882 issued May 8, 2001 to William A. Barr, U.S. Pat. No. 4,589,211 issued May 20, 1986 to Stanley J. Policka, U.S. Pat. No. 3,913,235 issued Oct. 21, 1975 to Milton T. Tenneson et al., and U.S. Pat. No. 3,745,664 issued Jul. 17, 1973 to Lukas G. Altseimer all disclose blind marking devises using ink or an ink pad fixed in a frame. While they all identify the corner locations or central field location where the wall material is to be removed, they require the use of custom outlet boxes, and require re-use and storage of the device after it is used. Another problem with these types of devices is that they only work with electrical box outlets, and are not configurable for round or free-formed cut-outs.

What is needed is a universal marking system that can be configurable to any shape. The marking system need to be versatile enough to be disposable for custom marking of different shapes. The proposed application provides a solution to these problems with a universal blind marking system that works with a large variety of materials and shapes.

### BRIEF SUMMARY OF THE INVENTION

It is an object of the universal blind marking system to provide a marking system to identify where a hole or cut-out needs to be made in a location that a person can't easily identify. This system is ideal for identifying location behind wall board, cabinets, door locking bolts and appliances. When using the marking system to location where to cut or remove material is easy to identify.

It is an object of the universal blind marking system to provide a universal blind marking system that is versatile enough to be used with standard electrical outlet boxes and custom freeform shapes that would normally require multiple trial and error attempts to determine the location size and shape of the material to be removed. The system is further adaptable for use identifying where an electrical conduit cable needs to be located and where the bolt on a door lock will make contact in a door jam.

It is another object of the universal blind marking system to provide pads that are pre-configured for locating the corners of square and rectangular boxes as well as strips of pad material that for placement along straight sections. Round pads are also provided to mark the center of a hole and where an electrical wire or conduit will be placed through a wall. In addition to pre-configured pad shapes, blank pad material is configurable by cutting, or with other common tools, to fabricate a custom shape at the job site. The marking pads are disposable to eliminate the need to retrieve, save, and store used marking pads.

It is another object of the universal blind marking system to provide marking pads that are pre-loaded with marking material. The pads are located on an adhesive backing that is removed to apply the pads on the surface or shape that needs to be identified. Once the pad(s) are applied a top cover is removed to expose the marking pad. The pads are available in various thicknesses to accommodate different thickness variations between the area to be marked and the surface where the marking is to be applied.

It is another object of the universal blind marking system to have a porous top layer bonded to a permeable middle layer permeated with marking colorant that is bonded to an bottom adhesive substrate such that when the bottom adhesive substrate is adhered to an object and the object is pressed against a surface the porous top layer is compressed into the permeable middle layer and some of the marking colorant permeates through the porous top layer and transfers some of the marking colorant to the surface.

It is another object of the universal blind system to have a shape having top release liner adhered to a top adhesive layer bonded to an identification layer bonded to a bottom adhesive layer adhered to a bottom release liner wherein the top adhesive layer has greater adhesive properties than the bottom adhesive layer. When the bottom and top release liners are removed from the bottom and top adhesive layers, the shape is placed on an object and then the object is pressed onto a surface to essentially sandwich the shape the shape will transfer from the object to the surface.

It is still another object of the universal blind marking system to use marking ink that remains in a liquid condition for an extended period of time allowing the installer to mark the location. This allows the installer to ink or expose a pre-inked pad and have time to work with the pieces without the need to immediately transfer the mark before the ink dries.

Various objects, features, aspects, and advantages of the present universal blind marking system will become more apparent from the following detailed description of preferred embodiments of the invention, along with the accompanying drawings in which like numerals represent like components.

### BRIEF DESCRIPTION OF THE DRAWINGS

FIG. 1 shows an isometric view of the universal blind marking system installed on a standard outlet receptacle.

FIG. 2 shows an isometric view of the universal blind marking system installed on a custom ducting shape.

FIG. 3 shows an isometric view of the universal blind marking system with the installation of rectangular ducting and an electrical conduit on a typical appliance.

FIG. 4 shows a die-cut marking pad that is used in the system to mark different corners and spots.

FIG. 5 shows a view of the universal blind marking system being used to mark shelf brackets.

FIG. 6 shows a view of the universal blind marker being used to mark a picture frame.

FIG. 7 shows a view of a porous and permeable pad.

FIG. 8 shows a view of a porous and permeable pad and marking colorant being transferred.

FIG. 9 shows a view of a high tack and low tack sheet of marking labels.

FIG. 10 shows a view of a high tack and low tack marking labels shown in a stacked configuration.

### DETAILED DESCRIPTION

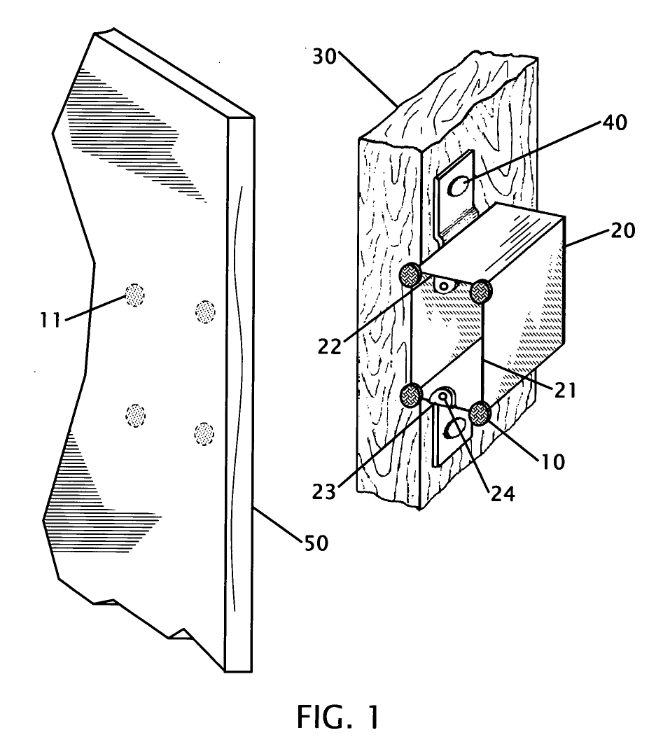

FIG. 1 shows an isometric view of the universal blind marking system installed on a standard outlet receptacle. The system includes a pad 10 that has ink, paint or similar marking agent on the surface of the pad. In this figure, four pads 10 are placed on the outer corners of a typical electrical outlet junction box 20. The electrical junction box shown is one of the most common size and shape, having two elongated vertical sides 21 and two shorter horizontal sides 22. While the single outlet type is shown, it is contemplated that the universal blind marking system works with electrical junction boxes that accommodate multiple outlets as well as round electrical boxes. Additional configurations are shown and described herein.

In a typical installation of an electrical box, the box 20 is secured to a wall stud 30. In the installation of an electrical box for a ceiling fan, the electrical box is often secured between two studs or joists (not shown). The front face of the electrical box 20 is usually placed some distance out from the face of the stud 30. The electrical box is typically placed such that the outer edge of the electrical box is flush with the outer surface of the drywall. The box shown here is secured to the stud with nails 40, but could also be installed using a number of others methods such as screws or other fastening hardware. This requires removing some material from the drywall or sheet rock 50 to clear the outside edge of the electrical box 20. The electrical box shown includes two bent tabs 23 with each tab having a tapped hole 24 for securing an electrical outlet or switch when the final electrical wiring is completed. The location where to cut an opening for the electrical box is difficult because the electrical box in located behind the sheet rock, drywall, or cabinet 50.

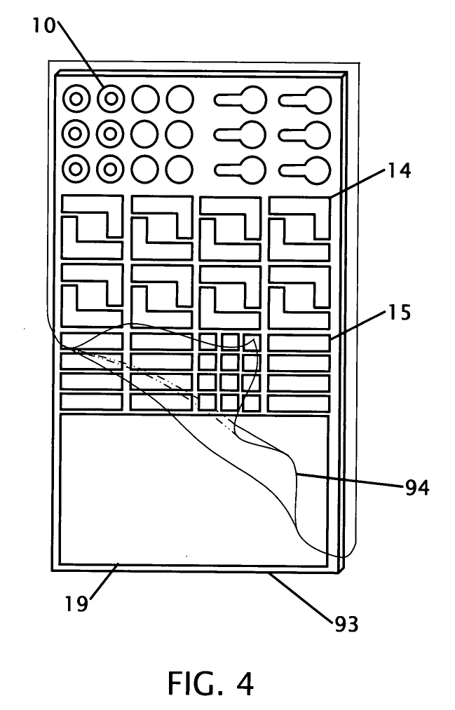

In operation the universal blind marking system, one or more pads 10 are placed on the corners, sides, edges or other locations where marking is desired. In FIG. 4 a variety of pre cut and formable marking pads are disclosed. In one contemplated embodiment the pads are pre-loaded with marking ink or die. In another contemplated embodiment the pads do not have marking media or ink applied on the pads and the ink is rubbed or applied to the pads after they are installed in position on the item to be marked. The wall, cabinet, door, wood, ceiling tile or other material that is to be marked is brought in place over the pads, and pressed onto the pads where some of the marking die is transferred onto the surface 11. The surface is then brought away and can then be marked with a straight edge or simply cut from marked point to marked point.

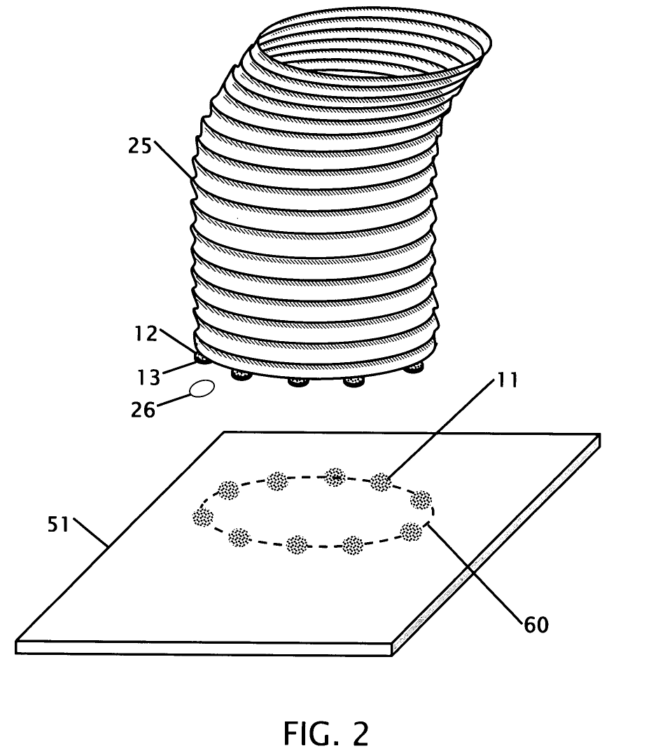

FIG. 2 shows an isometric view of the universal blind marking system installed on a custom ducting shape. In this figure a round or elliptical cut-out need to be made to allow the ducting to pass through the board 51. The location and shape of this type of ducting 25 is common in a number of construction installations. Determining the location, size and shape of the cut-out is often performed by trial and error, and often the hole is either made larger than required or is cut in the wrong location.

Pads from the universal blind marking system are placed on the end of the duct 25. One side of the adhesive pad 12 slicks to the duct 25. After the pad is applied to the duct, a protective covering 26 over the marking pad is removed exposing the marking surface 13. The board 51 is brought into position onto the bottom of the duct and the location of the pads is marked 11 on the board. The installer can the determine the center position of the circle or can cut 60 between the marked spots 11, or on the outside of the marked spots depending upon the desired clearance between the duct 25 and the wall 51.

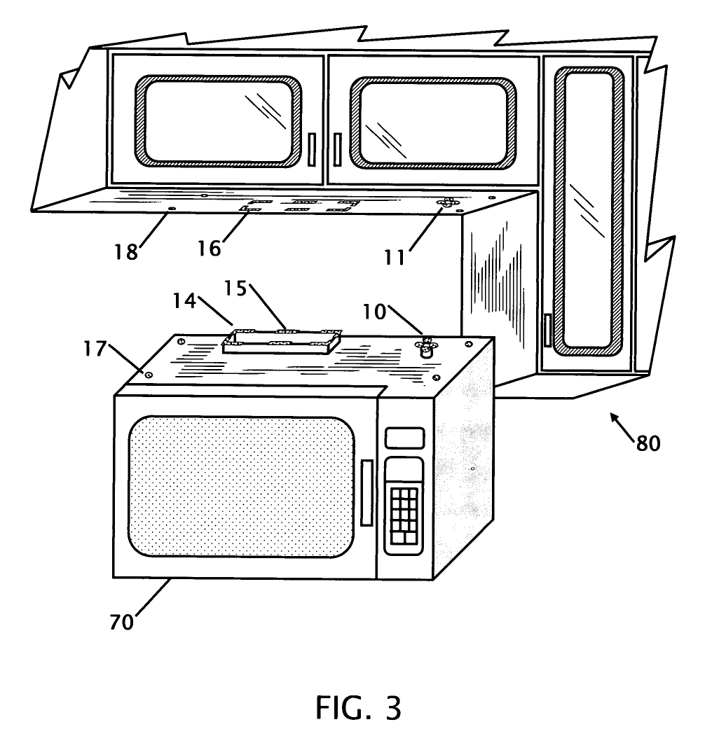

FIG. 3 shows an isometric view of the universal blind marking system with the installation of rectangular ducting and an electrical conduit on a typical appliance. This is a typical installation where an appliance 70 is installed in a cabinet 80. The appliance has multiple areas on the top that require holes for installation. In this installation there are holes for venting and electrical conduit that exist at one height on the appliance and mounting holes that exist at another height on the appliance. At the first height of installation, round pads are placed around the electrical conduit position 10. A combination of straight pads 15 and “L” or corner pads 14 are placed on the four corners of the duct 14. After these pads are placed on the appliance, the appliance in lifted into position on the cabinet and the mark for the exhaust duct 16 and the electrical conduit location 11 are transferred onto the cabinet. These holes are cut to provide the required clearance. Marking pads are then placed in the locations where the mounting/retaining hardware is located 17 on the outer corners of the appliance. The appliance is brought into position on the cabinet and these locations are marked 18 on the cabinet. The appliance is again brought down and the holes for the mounting hardware can be made.

The pads provide the function of marking locations where it would be nearly impossible to mark because the location exists where there is little or no clearance. These locations are normally called “blind” locations because they can not be seen under normal installation circumstances. In most situations the marking pads are disposable, but it is also contemplated that the pads can be reused if desired.

The pads are adaptable to a variety of marking needs. The adaptability is from the ability of the installer to place one or more pads on the high spots or where they want marked. The pads exist as pre-inked or as inkable pads where ink is applied when the pads are installed. It is contemplated that the pads be available in one shape/size or in a variety of shapes and sizes as well as allowing the installer to make a custom size to match a particular feature. One contemplated embodiment of the pads is shown and described in FIG. 4 herein.

FIG. 4 shows a die-cut marking pad that is used in the system to mark different corners and spots. In the preferred embodiment the basic pad material 10 is felt based, but other materials such as but not limited to foam, rubber, felt or other materials that can hold and transfer coloring as well as being resilient enough that they can be compressed are contemplated. The pad thickness is preferably 1/16 inch thick, but other thicknesses are contemplated that do not alter the operation of the system. In this figure round pads 10, “L” pads 14, strips 15 and user configurable area 19 are located on a backing sheet 93. Other shapes are contemplated that include but are not limited to round, square, rectangle, star, strips, holes and keyways. The bottom of the pads has an adhesive that allow the pads to stay in position. The plurality of pads is die cut in position on the pad where the excess material is removed, or the excess material around the pads is retained. This figure shows a protective cover 94 over the pads. The protective cover is used with pre-inked pads and extends the drying time of the marking ink.

The type of ink is variable based upon a number of factors including but not limited to the drying time, ease of installation on the pad and clean-up. It is desirable that the ink is cleanable with water, and that it have a drying time of five to ten minutes to provide time for the installer to mark the surface, and minimize ink transfer to other surfaces.

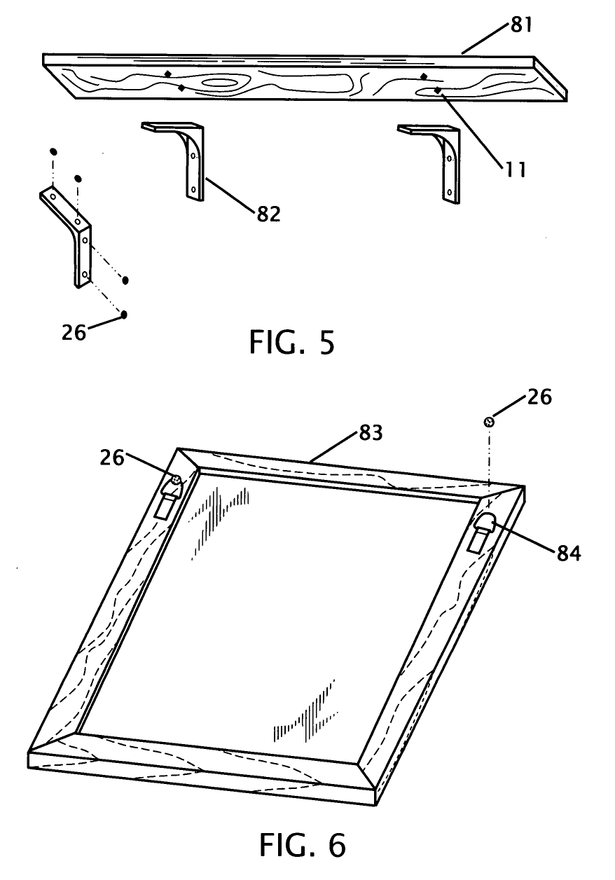

FIG. 5 shows a view of the universal blind marking system being used to mark shelf brackets. In this figure the marking pads 26 are placed on a corner brace 82. The marking pads are placed where the screws will be located on the wall or the shelf 11. The installer can use one corner brace and press it against the wall in a number of locations along a wall and then drill the holes for mounting the shelf 81. It is also contemplated that the marking pads can be placed on the end or edge of the shelf, and the shelf pushed against a wall to mark where the shelf will be located.

FIG. 6 shows a view of the universal blind marker being used to mark a picture frame. Hanging of picture frames is particularly difficult because the marked is behind the picture. The picture shown in FIG. 6 shows a frame with two wall hangers 84 mounted on the frame, but picture frames with a single mounting hanger or a wire hanger could also be installed with the marking system. From this figure the marking pads 26 are placed on the wall hangers where the nails, screws or other similar wall secured hardware will be located. When the picture 83 is in the desired location, the installer simply presses the upper portion of the picture against the wall and two marking spots are made. The installer then installs the wall hanging hardware and hangs the picture.

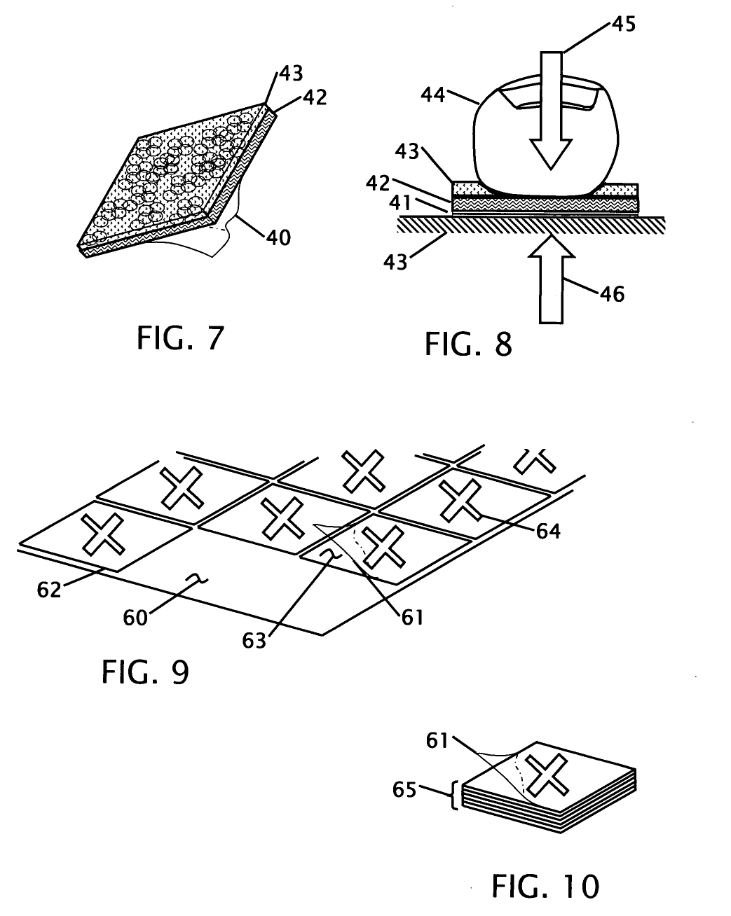

FIG. 7 shows a view of a porous and permeable pad. This figure shows the universal blind marking system to have a porous top layer 43 bonded to a permeable middle layer 42 permeated with marking colorant that is bonded to a bottom adhesive substrate 41. A release liner or paper protects the adhesive substrate until the pad is ready to be placed on an object. FIG. 8 shows that when the bottom adhesive substrate 41 is adhered to an object or surface 43 and the object 44 is pressed 45 against a surface 46 the porous top layer 43 is compressed into the permeable middle layer 42 and some of the marking colorant permeates through the porous top layer and transfers some of the marking colorant to the surface.

It is contemplated that the top porous surface is made from foam, cloth, fabric, felt, sponge or rubber. It is further contemplated that the inner permeable surface is made from foam, cloth, fabric, felt, sponge or rubber. The marking system has the advantage of being able to mark the high spot on a surface by proportionally marking areas of greater contact because the porous top layer is compressed in proportion to the high spot. Because only a portion of the marking material is transferred through the top pad the system is reusable several times until the marking media is used. The top porous surface provides the benefit of retards the marking colorant from transferring through the top porous layer from casual contact to the top porous layer and retarding the marking colorant from drying.

FIG. 9 shows a view of a high tack and low tack sheet of marking labels. In this embodiment the universal blind system is formed in a square shape, but other shapes are contemplated, having top release liner 61 adhered to a top adhesive 63 layer bonded to an identification layer 64 bonded to a bottom adhesive layer 62 adhered to a bottom release liner 60 wherein the top adhesive layer has greater adhesive properties than the bottom adhesive layer. When the bottom 60 and top release liners 61 are removed from the bottom and top adhesive layers, the shape is placed on an object and then the object is pressed onto a surface to essentially sandwich the shape the shape will transfer from the object to the surface.

In another contemplated embodiment the identification layer is marked with indicia such as, but not limited to circles, squares, rectangles, lines, keyways, targets, ellipses, dots, crosses, “X's”, characters, arrows, symbol(s) or combination thereof to further identify where a screw, or hole needs to be made.

The universal blind marking system has a top adhesive surface has twice the adhesive properties and the bottom adhesive layer.

The user can re-use the shape or can place a mark on the top or bottom surface of the adhesive side that will further identify what is being marked. Writing or marking on the adhesive surface will not significantly alter the adhesive properties of the top adhesive layer. The shape or user marking on the surface of the shape can be further used to identify the center of the shape or where to place a hole, hook, screw, nail or other object.

FIG. 10 shows a view of a high tack and low tack marking labels shown in a stacked 65 configuration where the top and bottom release liners comprise of a single release liner. It is also contemplated that the shape be provided in a flat sheet and the user can cut or form the shape to satisfy the needs to the item being marked.

Thus, specific embodiments of a universal blind marking system have been disclosed. It should be apparent, however, to those skilled in the art that many more modifications besides those described are possible without departing from the inventive concepts herein. The inventive subject matter, therefore, is not to be restricted except in the spirit of the appended claims.

1-3. (canceled)

4. A universal blind marking system comprising:
a porous top layer bonded to;
a permeable middle layer permeated with marking colorant that is bonded to;
a bottom adhesive substrate such that when the bottom adhesive substrate is adhered to an object and the object is pressed against a surface the porous top layer is compressed into the permeable middle layer and some of the marking colorant permeates through the porous top layer and transfers some of the marking colorant to the surface.

5. The universal blind marking system according to claim 4 wherein the porous top layer is selected from the group comprising of foam, cloth, fabric, felt, sponge and rubber.

6. The universal blind marking system according to claim 4 wherein the permeable middle layer is selected from the group comprising of foam, cloth, fabric, felt, sponge and rubber

7. The universal blind marking system according to claim 4 that further includes a removable protective cover located the porous top layer.

8. The universal blind marking system according to claim 4 that further includes a release liner located under the bottom adhesive substrate.

9. The universal blind marking system according to claim 4 wherein the assembly of the porous top payer, permeable middle layer and the bottom adhesive layer are constructed in a sheet that is die cut into shapes comprising round, square, rectangle, star, strips, holes and keyways.

10. The universal blind marking system according to claim 4 wherein the system provides a marking system for determining the high spot on a surface by proportionally marking areas of greater contact because the porous top layer is compressed in proportion to the high spot.

11. The universal blind marking system according to claim 4 wherein the porous top layer retards the marking colorant from drying.

12. The universal blind marking system according to claim 4 wherein the top porous layer retards the marking colorant from transferring through the top porous layer from casual contact to the top porous layer.

13. The universal blind marking system according to claim 4 wherein the universal blind marking system is reusable by removing the bottom adhesive substrate from the object and adhering the bottom adhesive substrate to a second object.

14. A universal blind marking system comprising:
a shape having top release liner adhered to;
a top adhesive layer bonded to;
an identification layer bonded to;
a bottom adhesive layer adhered to;
a bottom release liner wherein,
the top adhesive layer has greater adhesive properties than the bottom adhesive layer.

15. The universal blind marking system according to claim 14 wherein when the bottom and top release liners are removed from the bottom and top adhesive layers, the shape is placed on an object and then the object is pressed onto a surface to essentially sandwich the shape the shape will transfer from the object to the surface.

16. The universal blind marking system according to claim 14 wherein identification layer is marked with indicia.

17. The universal blind marking system according to claim 16 wherein the indicia is a circle, square, rectangle, line, keyway, target, ellipse, dot, cross, “X”, character, arrow, symbol(s) or combination thereof.

18. The universal blind marking system according to claim 14 wherein top adhesive surface has twice the adhesive properties and the bottom adhesive layer.

19. The universal blind marking system according to claim 14 wherein the shape is selected from a group comprising round, square, rectangle, star, strips, holes and keyways.

20. The universal blind marking system according to claim 14 wherein the identification is markable by a user without significantly altering the adhesive properties of the top adhesive layer.

21. The universal blind marking system according to claim 14 wherein the shape has a hole through the center of the shape to identify the center of the shape.

22. The universal blind marking system according to claim 14 wherein system is fabricated from a stacked plurality of universal blind larking systems as described in claim 11 where the top and bottom release liners comprise of a single release liner.

23. The universal blind marking system according to claim 14 wherein the shape is configurable with tools to make a custom shape.
